(19) United States
(12) Patent Application Publication
(10) Pub. No.: US 2009/0113350 A1
(43) Pub. Date: Apr. 30, 2009

(54) SYSTEM AND METHOD FOR VISUALLY SUMMARIZING AND INTERACTIVELY BROWSING HIERARCHICALLY STRUCTURED DIGITAL OBJECTS

(76) Inventors: Stacie Lynn Hibino, San Jose, CA (US); Jiajian Chen, Atlanta, GA (US)

Correspondence Address: Frank Pincelli, Patent Legal Staff;Patent Legal Staff, Eastman Kodak Company, 343 State Street, Rochester, NY, 14650-2201, US

(21) Appl. No.: 11/924,973

(22) Filed: Oct. 26, 2007

(51) Int. Cl. G06F 3/048

(52) U.S. Cl. 715/853

(57) ABSTRACT

A system and method of visually summarizing a hierarchically structured set of digital objects and for facilitating efficient access to such objects through the selection of representative summary objects. These digital objects are typically media objects such as digital image files, digital video clips, digital audio objects, such as “MP3” files, or other digital documents, such as text documents, that can be collected by a user and distributed over a variety of storage media and storage locations.

### FIELD OF THE INVENTION

The present invention relates to providing a visual overview pertaining to hierarchically organized digital objects. In particular, the present invention pertains to the formation and display of ordered visual representations, where, each displayed visual representation symbolizes a different node, wherein all symbolized nodes belong to one level in the object hierarchy. The visual representation can be obtained from nodes descendant from the symbolized node, or generated separately.

### BACKGROUND OF THE INVENTION

Increased computer usage and creation of digital objects along with decreasing costs in removable memory, fixed hard disks, and network access have all contributed to the increase in the number of digital objects any individual person may own or want to access. Computer users have moved from tens or hundreds of files to thousands of files or more. Similarly, digital cameras have decreased in physical carrying size and increased in memory capacity, making it easy for users to carry cameras with them more often and capture more pictures and video clips per picture-taking opportunity. As personal digital media collections increase in magnitude, they are also becoming more and more cumbersome for users to manage and access.

Typically, as in a file system, users can easily view digital objects by browsing a hierarchical directory and file structure. Tree based representations are typically provided for users in a graphical user interface (GUI), making it simple for users to view any objects in any given directory. Unfortunately, it is challenging for users to access object leaf nodes from more than one directory at once. In addition, users are not provided with any visual summary information about what is contained within a directory, especially not for objects that are deeply nested below any given directory. Furthermore, a file system view does not provide flexibility for viewing other hierarchical organizations based on other data facets for the same set of digital objects. That is, if a user creates a folder and file structure based on temporal information such as year, then month, etc., then the user is limited to browsing only by that temporal information within the file browser. They cannot, for example, use the file browser to browse the same files based on a hierarchical content-based categorization of the same data—not without first needing to duplicate files and create appropriate folders. Some modern digital object organization software provide support for viewing different data facets (e.g., for browsing by tags or date in a photo collection), but they do not provide a general approach for browsing any facet of hierarchical data. Accordingly, a need exists in the art for an improved way to review and organize digital objects.

### SUMMARY

The above-described problems are addressed and a technical solution is achieved in the art by a system and a method for providing a visual summary pertaining to a collection of digital assets, according to the present invention. In one embodiment of the present invention, information pertaining to a collection of digital objects is provided by a computer implemented method including the steps of locating a collection of digital objects that are stored on a computer system and which are organized in a hierarchical fashion, and then simultaneously displaying visual representations of digital objects that belong to a selected level of the hierarchy. This is a useful method because computer users typically group and label text documents and image files in such a hierarchical fashion, wherein nested folders, subfolders, and files are appropriately labeled. Digital objects of the present invention may also include video clips and presentation documents. The visual representations may include thumbnails versions of digital objects, a manually created or computer generated representation, an icon, and a montage.

Further embodiments of the present invention include recognizing depth and height levels of a hierarchy and their interrelationships, and selecting such levels for generating visual representations to depict the levels. Other embodiments of the present invention include recognition of leaf nodes and container nodes of the hierarchy, and their ancestry in the hierarchy. Another embodiment of the present invention is selection of a pattern to display the visual representations, such as in a spiral pattern. The present invention can be used to visually summarize hierarchies based on time, events, people, image and document contents, and geographic location.

Other embodiments of the present invention include a computer system suitably programmed to implement the methods of this invention. Such a computer system includes a processor and memory for organizing and storing a plurality of digital objects in tree hierarchy. The processor executes programs for visually summarizing certain ones of the digital objects that belong to a selected level of the hierarchy. A display screen is coupled to the computer system for displaying visual representations comprising the visual summary. In response to a user selecting a depth of the hierarchy to display, the system can then display a visual summary of the corresponding level of the hierarchy, and so on for additional lower depths. This is a top-down embodiment of the present invention (e.g. hierarchy depth). The system can also start with a visual summary of a lowest level of the hierarchy and successively display; higher levels, which is referred to as a bottom-up embodiment of the present invention (e.g. hierarchy height).

Other embodiments that are contemplated by the present invention include computer readable media and program storage devices tangibly embodying or carrying a program of instructions readable by machine or a processor, for having the machine or computer processor execute instructions or data structures stored thereon. Such computer readable media can be any available media, which can be accessed by a general purpose or special purpose computer. Such computer-readable media can comprise physical computer-readable media such as RAM, ROM, EEPROM, CD-ROM, DVD, or other optical disk storage, magnetic disk storage or other magnetic storage devices, for example. Any other media which can be used to carry or store software programs which can be accessed by a general purpose or special purpose computer are considered within the scope of the present invention.

These, and other aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications. The figures below are not intended to be drawn to any precise scale with respect to size, angular relationship, or relative position.

### BRIEF DESCRIPTION OF THE DRAWINGS

The present invention will be more readily understood from the detailed description of exemplary embodiments presented below considered in conjunction with the attached drawings, of which:

FIG. 1 is a block diagram of a computer system capable of practicing various embodiments of the present invention;

FIG. 2 is an example abstract tree representation of hierarchical data;

FIG. 3 is an example tree representation of hierarchical data, presenting nodes by tree depth;

FIG. 4 is an example tree representation of hierarchical data, presenting nodes by tree height;

FIG. 5 shows examples of nodes and data from FIG. 3 to display, based on top-down browsing of the hierarchy;

FIG. 6 shows examples of nodes and data from FIG. 4 to display, based on bottom-up browsing of the hierarchy;

FIG. 7 is a flow chart for generating the list of nodes to display for top-down browsing of the hierarchy;

FIG. 8 is a flow chart for generating the list of nodes to display for bottom-up browsing of the hierarchy;

FIG. 9 is a flow chart for generating a first ordered list of visual objects to display, based on list of nodes to display generated by FIG. 7 or FIG. 8;

FIG. 10 is a flow chart for generating a second ordered list of visual objects to display;

FIG. 11 shows examples of leaf nodes from FIG. 3 to display, based on selection of different nodes depicted in FIG. 5;

FIG. 12 shows examples of leaf nodes from FIG. 3 to display, based on selection of a node depicted in FIG. 5 or a node depicted in FIG. 6;

FIG. 13 shows a screen capture of a working prototype implementing an embodiment of the present invention, displaying thumbnail images of a first list in a grid layout;

FIG. 14 shows a screen capture of the same working prototype, displaying thumbnail images of a first list in a spiral layout;

FIG. 15 shows a screen capture of the same prototype, after a thumbnail from FIG. 14 has been selected;

FIG. 16 shows a screen capture of the same prototype, with an interactive bar plot filter for filtering the current data being displayed;

FIG. 17 shows the results of expanding all thumbnail images of FIG. 16; and

FIG. 18 is an example tree representation of hierarchical data, presenting nodes by tree depth.

It should be understood that the attached figures are for purposes of illustrating the concepts of the invention and may not be drawn to scale.

### DETAILED DESCRIPTION

Embodiments of the present invention relate to an effective method of representing a hierarchically structured collection of digital objects, and for facilitating efficient access to such objects through the selection of individual thumbnails or nodes in the hierarchy. These digital objects are typically media objects such as digital image files, digital video clips, digital audio objects, such as “MP3” files, or other digital documents that can be collected by a user and distributed over a variety of storage media and storage locations. However, these objects need not be limited to multimedia objects. Text files can also be represented according to the methods of the present invention.

When users only have a small number of digital objects, they can easily organize them hierarchically using a standard file and folder representation as typically provided by a modern computer operating system. For example, consider a folder hierarchy for pictures viewed in the File Explorer application of Microsoft Windows XP. Using such a standard file and folder hierarchy, users can access items in a straightforward manner by clicking on individual folders. They can opt to view thumbnails of images or view them in a “filmstrip” format, enabling them to preview images without having to open them. Unfortunately, when users' collections grow to thousands of objects, the simple file and folder access available via the operating system can become cumbersome. In order to access media deep in a file system structure, users have to expand each subfolder along the way. They also cannot view the contents of two subfolders together unless they open two separate File Explorer windows and navigate to the appropriate place. Although modern file system views can provide a visual summary of media files such as showing thumbnails of underlying content on folder icons, such visual summaries are only provided for one level of depth in a hierarchy—i.e., for only the immediate “child” media of a given folder node. Two major limitations of using a current standard file and folder hierarchy organization for accessing hierarchically organized media today are thus: 1) visual representations are not available for deeply nested media; and 2) users are limited to accessing only immediate child media at any given node in the hierarchy (i.e., they do not have easy access to all descendant media from any node at any level in the hierarchy).

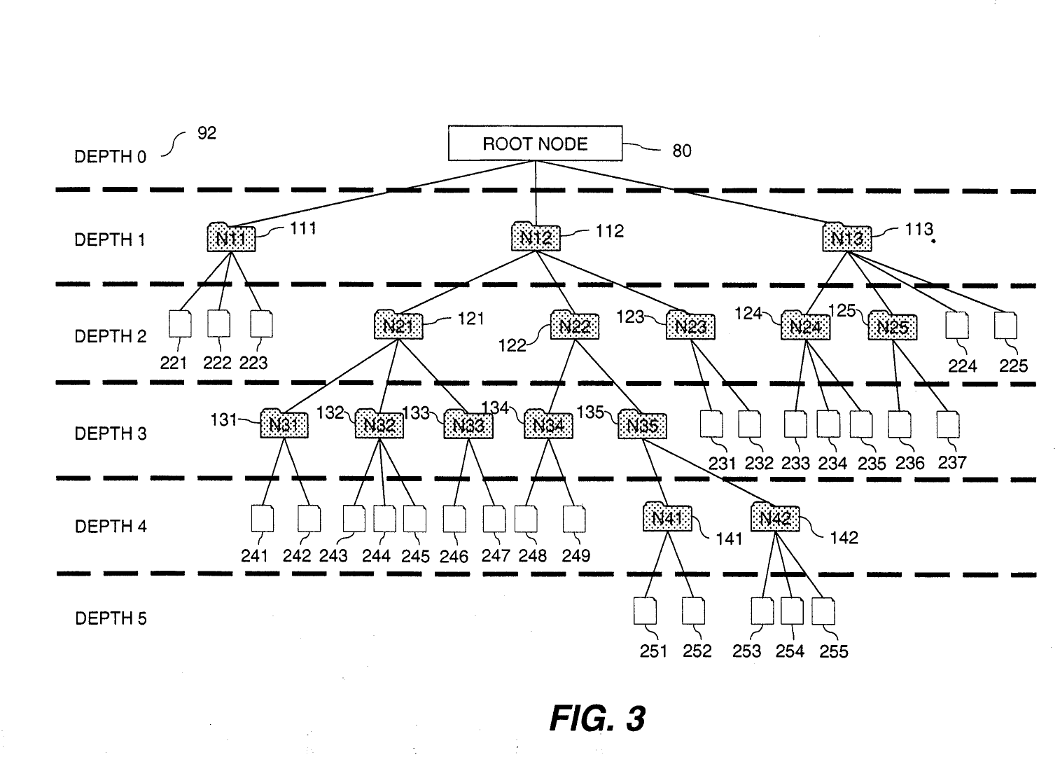

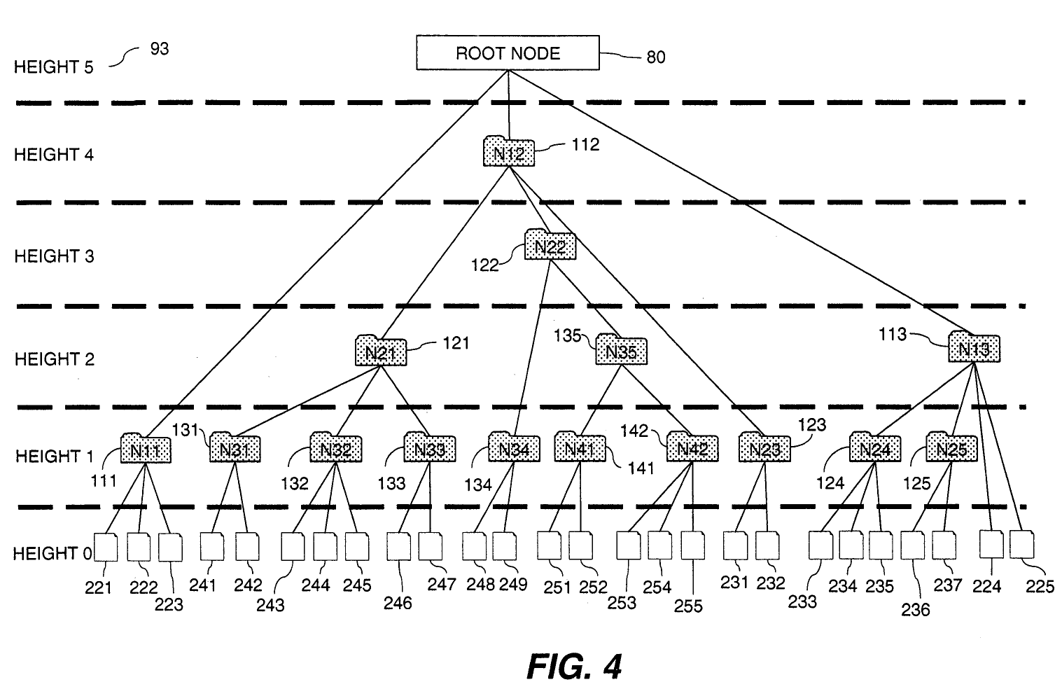

In accordance with an embodiment of the present invention, a more compact and efficient method of browsing a hierarchically organized set of documents such as a digital image collection stored in folders and files is to provide a visual summary of nodes of the set, based on user-selected level of the hierarchy to view. The level of hierarchy can be based on node depth, as described in more detail below in relation to FIG. 3, or node height, as explained in more detail below in relation to FIG. 4. This provides the user with a visual summary of a horizontal slice through, or a level of, the hierarchy. Furthermore, in accordance with another embodiment of the present invention, given a visual summary list of nodes as described above, users can easily access all descendant leaf nodes of a selected summary node, independent of the height of the leaves.

For example, consider the typical case where users organize their photo collection on their home computer in file folders based on date and event. At the top level of their photo collection, they have file folders for each year. Within each year folder, they have folders organized by month and event information (e.g., events such as a birthday party, vacation, wedding, day hike, holiday, etc.). Within each of those folders, they may have additional subfolders, usually depending on the number of pictures captured for a given event. For example, pictures from a vacation to Europe might be in a folder called “May 2007 trip to Europe” and then further divided into country visited folders and country folders could be further divided into major cities, activities or famous landmarks. In accordance with an embodiment of the present invention, the user could choose to view the top level folder nodes which, in this example, would present the user with one representative visual summary object per year. Such a visual summary object could be a single picture from a particular year such as the first picture of the year or a picture from a subfolder containing the most pictures. The visual summary object could also be a visual summary that is created by the system or the user, such as a montage (e.g., a montage composed of pictures from different subfolders). Once presented with the visual summary of years, users can select a year node to view all images captured during that year, independent of how deeply nested those images might be within the year folder.

In the above example, year folders represent nodes at depth=1 in the hierarchy. Moving down one level in the hierarchy (i.e. in all year folders), folders within each year folder (month folders and event information folders) are at depth=2 and can represent user-specified events that took place during that year. Thus, in one embodiment of the present invention, users can choose to view folder nodes at depth=2 to get a visual overview of all major events of all years at once.

The present invention is not limited to browsing the hierarchy from the top-down by depth level, but also provides browsing the hierarchy from the bottom up by node height level. As a brief example, given a sample hierarchy as illustrated in FIG. 3, where nodes are presented by depth level, FIG. 4 shows how the same hierarchy can be depicted in terms of node height. Folder n12 112 shown in FIG. 3 and in FIG. 4 represents a node having a depth level=1 and a height level=4 and which contains several depths of folders, similar to that described above for a vacation to Europe. Consider again the case of the example above of a user's collection organized by year folders and then by event folders and so on. As mentioned above, events may vary in size and subfolder depth, typically dependent on the number of pictures captured for an event. The bottommost subfolders of such a collection represent an atomic-level of events for users. In accordance with an embodiment of the present invention, bottom-up browsing of events provides users with easy access to such atomic-level events, independent of the depth of the corresponding nodes. Thus, this would allow a user to see the “Eiffel Tower” node of pictures right next to the “Roman Coliseum” node of pictures, even if they were at different depths in the hierarchy, as long as they were at the same height in the hierarchy.

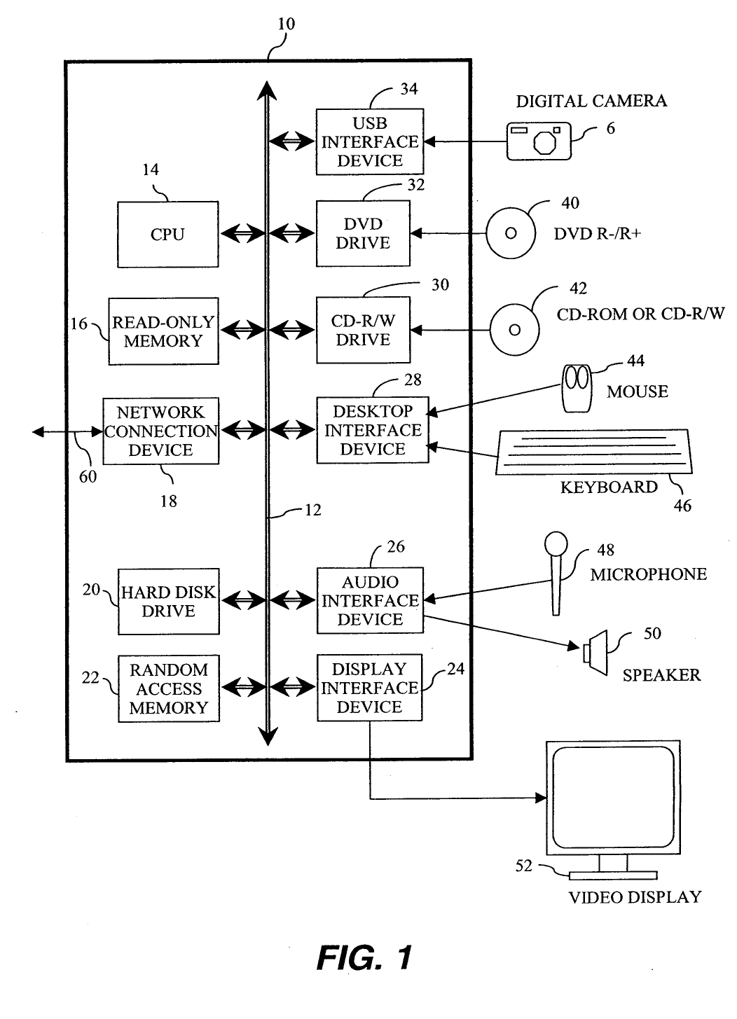

FIG. 1 shows one type of system for practicing an embodiment of the present invention. In this example, the system includes a computer 10, which typically includes a keyboard 46 and mouse 44 as input devices communicatively connected to the computer's desktop interface device 28. The term “computer” is intended to include any data processing device, such as a desktop computer, a laptop computer, a mainframe computer, a personal digital assistant, a cell phone, a digital camera, a smart phone device, and/or any other device for processing data, and/or managing data, and/or handling data, whether implemented with electrical and/or magnetic and/or optical and/or biological components, and/or otherwise. Any of the above-mentioned computers, need not include all the components illustrated in FIG. 1. The system illustrated in FIG. 1 is intended to cover many embodiments of a computer system. Therefore, taken altogether, the system illustrated is more than sufficient for implementing embodiments of the present invention. The phrase “communicatively connected” is intended to include any type of connection, whether wired, wireless, or both, between devices, and/or computers, and/or programs in which data may be communicated. Further, the phrase “communicatively connected” is intended to include a connection between devices and/or programs within a single computer, a connection between devices and/or programs located in different computers, and a connection between or within devices not located in computers.

Output from the computer 10 is typically presented on a video display 52, which may be communicatively connected to the computer 10 via the display interface device 24. The display may also be disposed in the same housing as the computer 10. Internally, the computer 10 contains components such as a CPU 14 communicatively connected to bus 12 and computer-accessible memories, such as read-only memory 16, random access memory 22, and a hard disk drive 20, all communicatively connected to the bus, and which may retain some or all of the digital objects referred to herein. The phrase “computer-accessible memory” is intended to include any computer-accessible data storage device, whether volatile or nonvolatile, electronic, magnetic, optical, or otherwise, including but not limited to, floppy disks, hard disks, compact discs, DVDs, flash memories, ROMs, and RAMs.

The CPU 14 communicates with other devices over data bus 12. The CPU 14 executes software that can be stored on the computer accessible memories. In addition to hard disk drive 20, the computer 10 may also contain other connectible computer-accessible memory drives for reading and writing data and software of various types. This may include a CD-RW drive 30 for reading and writing various CD media 42 as well as a DVD drive 32 for reading and writing to various DVD media 40. Audio can be input to the computer 10 through a microphone 48, or other storage device, for example, an MP3 player, communicatively connected to an audio interface device 26. Audio playback can be heard via a speaker 50, or other listening devices, also communicatively connected to an audio interface device 26. A digital camera 6, and most any of the devices discussed herein, or other image capture or storage device can be communicatively connected to the computer 10 through, for example, the USB interface device 34 to transfer digital objects from the camera 6 to the computer accessible memories and vice-versa. Finally, the computer 10 can be communicatively connected to an external network 60 via a network connection device 18, thus allowing the computer to access digital objects from other computers, devices, or data-storage systems communicatively connected to the network. A “data-storage system” may include one or more computer-accessible memories, and may be a distributed data-storage system including multiple computer-accessible memories communicatively connected via a plurality of computers and/or devices, or over a network. On the other hand, a data storage system need not be a distributed data-storage system and, consequently, may include one or more computer-accessible memories located within a single computer or device.

A collection of digital objects can reside exclusively on the hard disk drive 20, compact disc 42, DVD 40, or on remote data storage devices, such as a networked hard drive accessible via the network 60. A collection of digital objects can also be distributed across any or all of these storage locations.

A collection of digital objects may be represented by a database that uniquely identifies individual digital objects (e.g., such as a digital image file) and their corresponding location(s) in the computer memories. It will be understood that these digital objects can be media objects or non-media objects. Media objects can be digital still images, such as those captured by digital cameras, audio data such as digital music or voice annotations, digital video clips with or without sound. Media objects could also include files produced by graphic or animation software such as those produced by Adobe Photoshop or Adobe Flash. Non-media objects can be text documents such as those produced by word processing software or other office-related documents such as spreadsheets or email. A database of digital objects can be comprised of only one type of object or any combination.

Once a collection of digital objects is associated, such as in a database or by another mechanism of associating data, the objects can be hierarchically organized according to a user created hierarchy (e.g., as in a traditional folder (i.e., directory) and file organization available at the operating system level). Alternatively, a hierarchical organization can be automatically derived based on information about the digital objects. For example, using the creation date of the digital object, a hierarchy of folders or container nodes can be formed based on year, month, and then day of month, only creating container nodes when necessary. That is, when a time-based hierarchy only includes years, months or days for which digital objects exist within the database. For the case of digital image files, the EXIF header, well known in the art, of an image captured from a digital camera can be used to provide the capture date for an image.

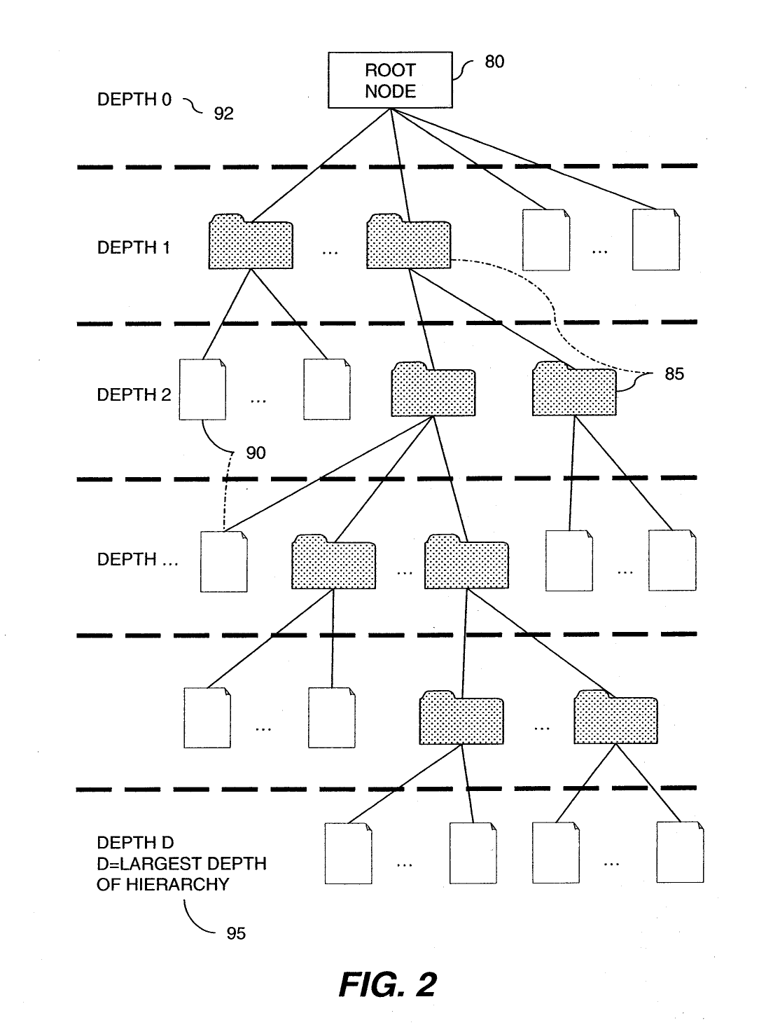

FIG. 2 is an example abstract tree representation of hierarchical data presented in terms of node depth. There are three types of nodes: the root node 80, container nodes represented by folder icons 85, and digital object leaf nodes represented by document icons 90. The depth of a node in a hierarchical tree data structure is determined by the number of levels a node is located from the root node. The root node 80 is at depth=0 92 and the depth of the hierarchical tree structure is equal to the largest depth=D 95 in the set. FIG. 3 provides a concrete example of a tree representation of hierarchical data presented in terms of node depth. In this example, the depth of the tree is 5 and the number of container nodes at depth=1 is three. The node n11 111 contains three documents 221, 222, 223. The same nodes in the example of FIG. 3 are shown in FIG. 4 where the tree representation of the same data is presented in terms of node height. The height of a node in a hierarchical tree data structure is equal to the maximum height a node is located from all of its descendant leaf nodes. Thus, the height of node n13 113 of FIG. 4 is height=2, and its depth is depth=1, whereas the height of node n11 111 has height=1 and depth=1. A leaf node has no descendants and always has height=0.

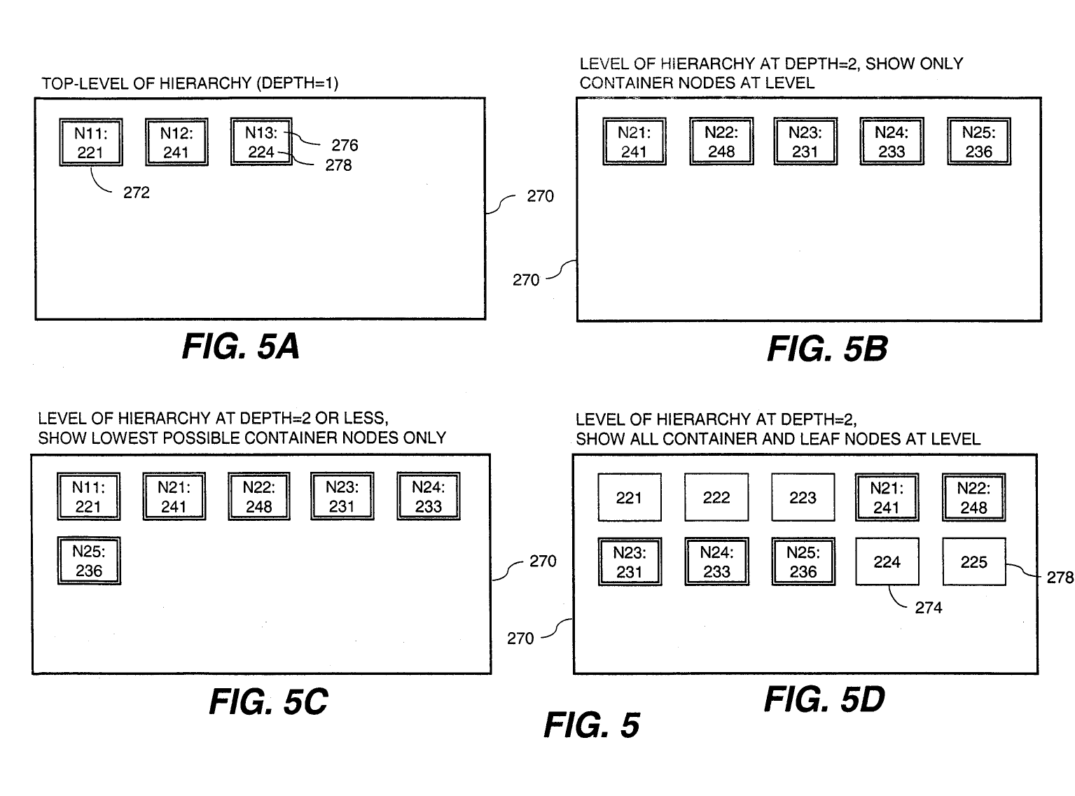

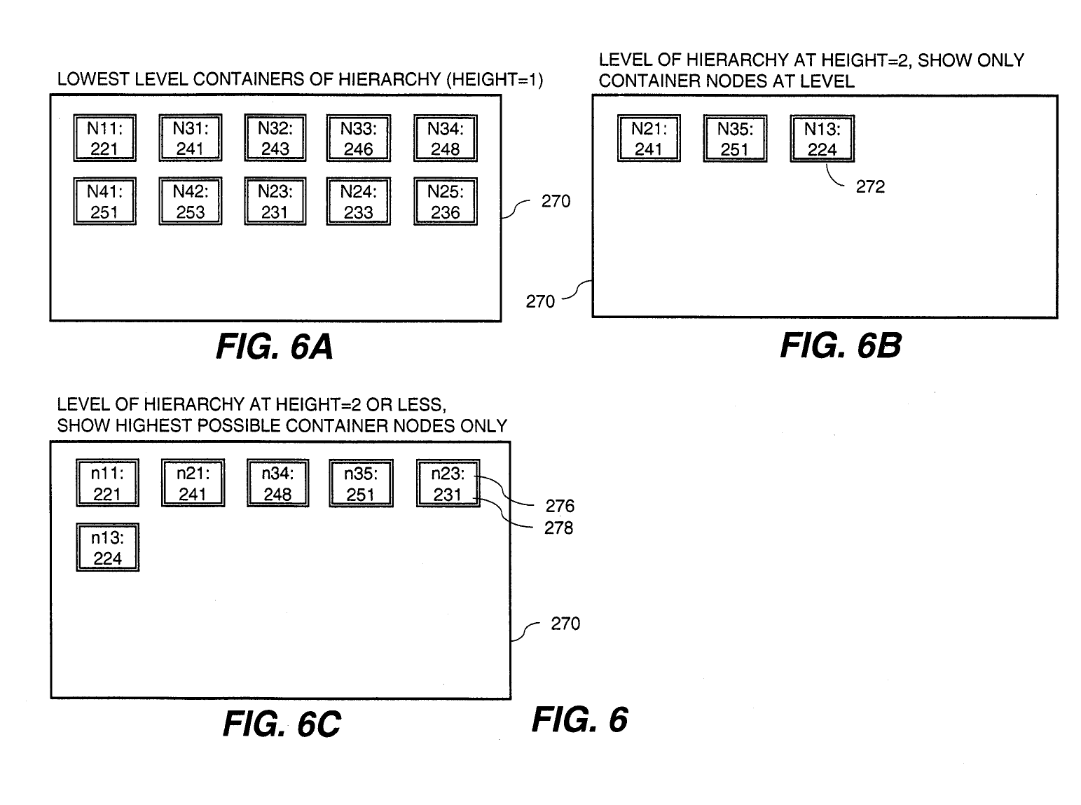

FIG. 5 shows examples of nodes and data from FIG. 3 presented on a display 270, based on top-down (depth) browsing of the hierarchy, whereas FIG. 6 shows examples of nodes and data from FIG. 4 presented on display 270, based on bottom-up (height) browsing of the hierarchy. Keep in mind that the hierarchical tree data illustrated in FIG. 3 and FIG. 4 contain the same data set. In both FIG. 5 and FIG. 6, nodes are abstractly displayed in a grid layout in display area 270. Container nodes are indicated by a double border 272, while digital objects are indicated by a single border 274. Container nodes have two values—the top value 276 represents the node id of a node from FIG. 3 and FIG. 4; the bottom value 278, indicates the id of a leaf digital object descendant from that node that could be used as a visual summary of that node. For example, if FIG. 3 represented a user's digital photo collection as saved on a home computer, then in accordance with an embodiment of the present invention, the user could view a summary of top-level nodes of the hierarchy (i.e., nodes where depth=1). As depicted in FIG. 5a, the three top-level nodes to present to the user would include nodes n11, n12, and n13 (i.e., 111, 112, 113 of FIG. 3). A thumbnail of a photo that is a descendant of each of those nodes is used to visually present each node to the user. In the examples in FIG. 5 and FIG. 6, such a descendant image is derived by first checking to see if the current node contains any images and if not, using a depth-first search for the first descendant image encountered, where depth-first search is well known in the art for data tree traversal. In FIG. 5a, a thumbnail of image 221 provides a visual representation for node n11, a thumbnail of image 241 provides a visual representation for node n12, and a thumbnail of image 224 provides a visual representation for node n13.

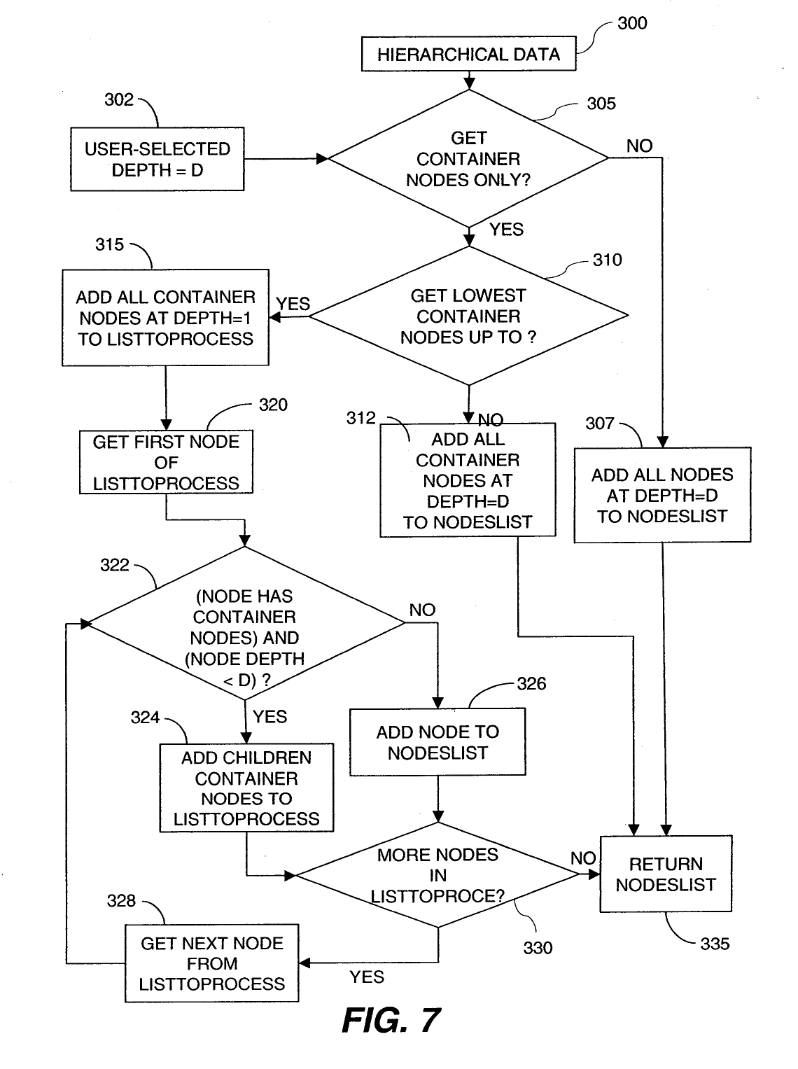

FIG. 7 provides a flow chart for generating the list of nodes to display for top-down browsing of the hierarchical data set as exemplified in FIG. 5. Based on a given hierarchical data set 300 and a user-selected depth=d 302, then in step 305, if the user wants to retrieve both container and leaf nodes at the specified depth, then all nodes at depth=d are added to the NodesList 307 and the NodesList is returned 335 for display. FIG. 5a shows an example of all nodes returned and displayed for depth=1 of the hierarchy of FIG. 3; FIG. 5d shows an example of all nodes returned and displayed for depth=2 of the hierarchy of FIG. 3.

In step 305, if the user wants to retrieve only container nodes, then the flowchart continues to step 310. In step 310, if the user is interested in only container nodes at the specified depth=d, then the flowchart continues to step 312 where all container nodes at depth=d are added to NodesList and then the NodesList is returned 335 for display. FIG. 5b shows an example of this for depth=2 of the hierarchy of FIG. 3. Note the contrast between returning only container nodes in FIG. 5b versus returning all container and leaf nodes in FIG. 5d for the same depth=2 of the hierarchical data of FIG. 3.

In step 310, if the user wants to retrieve the lowest container nodes up to and including the depth=d, then the flowchart proceeds to step 315. The method uses a breadth-first traversal of the hierarchy, by first adding all container nodes at depth=1 to ListToProcess 315, where ListToProcess is the working list of nodes to process. In step 320, the first node of ListToProcess is obtained and the method checks in step 322 to see if the node contains other container nodes and its depth is less than the depth=d specified by the user in 302. If the current container node does not have any children container nodes, then that current node is added to the NodesList in step 326. In step 330, we check to see if there are more nodes in ListToProcess. If no, then all necessary nodes have been processed and we can return the NodeList 335 for display. If yes, then in step 328, the next container node is retrieved from ListToProcess and we continue back through step 322. If in step 322, the current container node does have child container nodes and its depth is less than d, then in step 324 all children container nodes are added to the ListToProcess and the method continues to step 330. FIG. 5c shows the result of selecting and displaying lowest possible container nodes for depth=2 for the data hierarchy of FIG. 3. In contrast to FIG. 5b, this has the effect of including node n11 (111 in FIG. 3) in the NodesList of nodes to display.

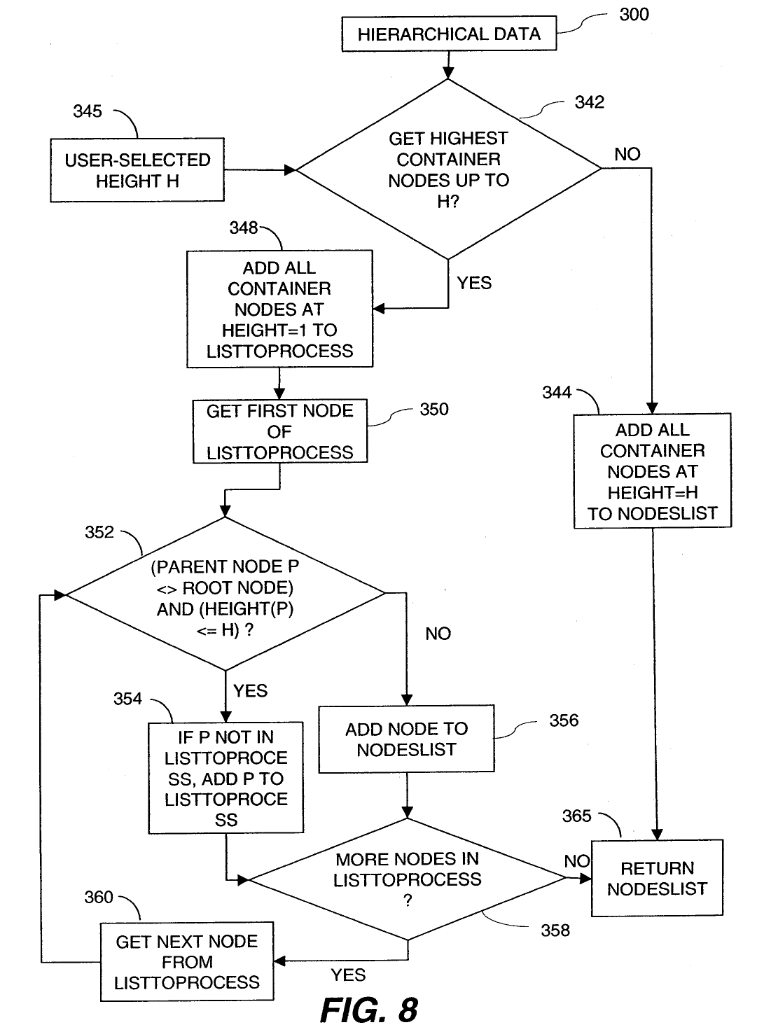

FIG. 8 provides a flow chart for generating the list of nodes to display for bottom-up browsing of the hierarchical data set as exemplified in FIG. 6. Given a hierarchical data set 300 and a user-selected height=h 345, then in step 342, if the user wants to only get the container nodes at height=h, then all container nodes at height=h are added to NodesList in step 344 and the NodesList is returned in step 365 for display. FIG. 6a shows the example of displaying all returned container nodes at height=1; FIG. 6b shows the example of displaying all returned container nodes at height=2.

In step 342 of FIG. 8, if the user has opted to get the highest container nodes up to and including those at height=h, then the flowchart continues to step 348. The flowchart from step 348 is based on a breadth-first, bottom-up traversal of the tree. In step 348, all container nodes at height=1 are added to the ListToProcess, which represents the pending list of nodes to process. In step 350 the first node of ListToProcess is obtained and becomes the current node. In step 352, if the parent node p of the current node is not the root node 80, and the height of the parent node is less than or equal to the specified height h, then in step 354, the parent node p is added to the ListToProcess if it is not already included in that list. In step 358, if there more nodes to process, then the next node from ListToProcess is retrieved in step 360 and the method loops back to step 352. If, in step 352, either the parent is the root node OR the height of the parent is greater than the height h specified, then the current node is added to the NodesList in step 356 and the flowchart proceeds to step 358 to check if there are more nodes to process. The flow continues from step 358 as indicated above. FIG. 6c provides an example of displaying the highest possible container nodes for height=2 of the hierarchical data from FIG. 4. Contrast this with FIG. 6b, where only the containers at height=2 are included. FIG. 6c also includes the nodes n11, n34, and n23, 111, 134, and 123, respectively, of FIG. 3.

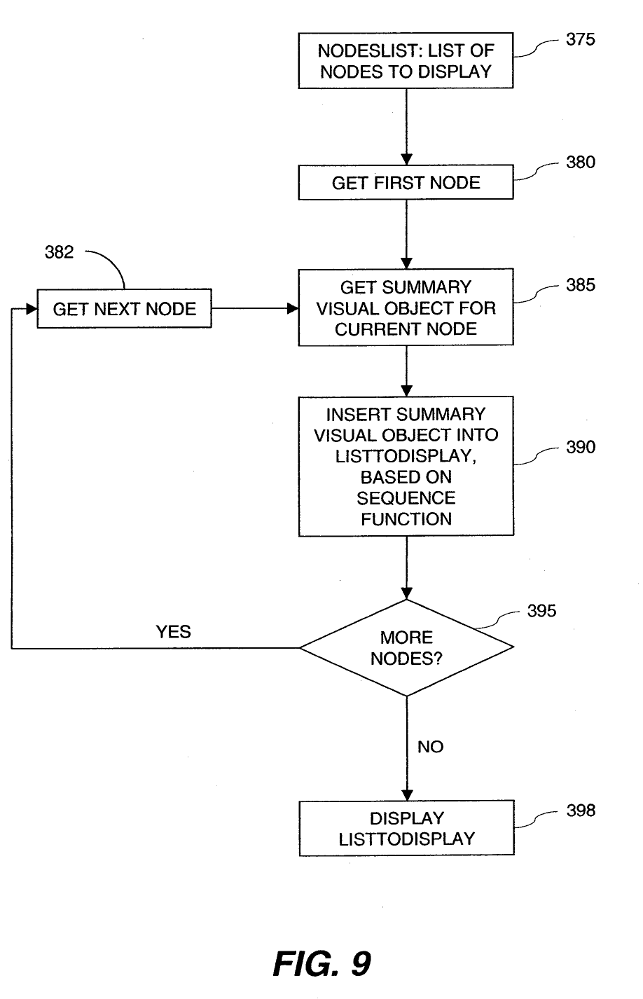

Once a list of nodes (NodesList) has been identified via one of the flowcharts in FIG. 7 or FIG. 8, the system must identify a corresponding list of representative visual summary objects to display. FIG. 9 provides a flowchart for generating such a first ordered list of visual objects to display (ListToDisplay). Given a NodesList in step 375 of FIG. 9, the first node from the list is retrieved in step 380. In step 385, the system retrieves a summary visual object for the current node. As described above, such a visual summary object can be, for example, a simple thumbnail image that is a descendant of the current node, or a more complex montage; it could also be manually specified or created by the user, or algorithmically derived by the system. In step 390, the summary visual object is inserted into the ListToDisplay, based on a sequence function. The sequence function could be, for example, a temporal ordering of visual objects based on capture date, or creation date if the object is a text document, or alphabetical ordering based on a node label, etc. If the ListToDisplay contains a text document, then a thumbnail of a title page, image contained within the text document, or table of contents can be used as a summary visual object. In step 395, if there are more nodes from the NodesList to process, the next node is retrieved in step 382 and the flow loops back to step 385. If there are no more nodes to process in step 395, then the ListToDisplay of summary visual objects and corresponding node information are returned in step 398.

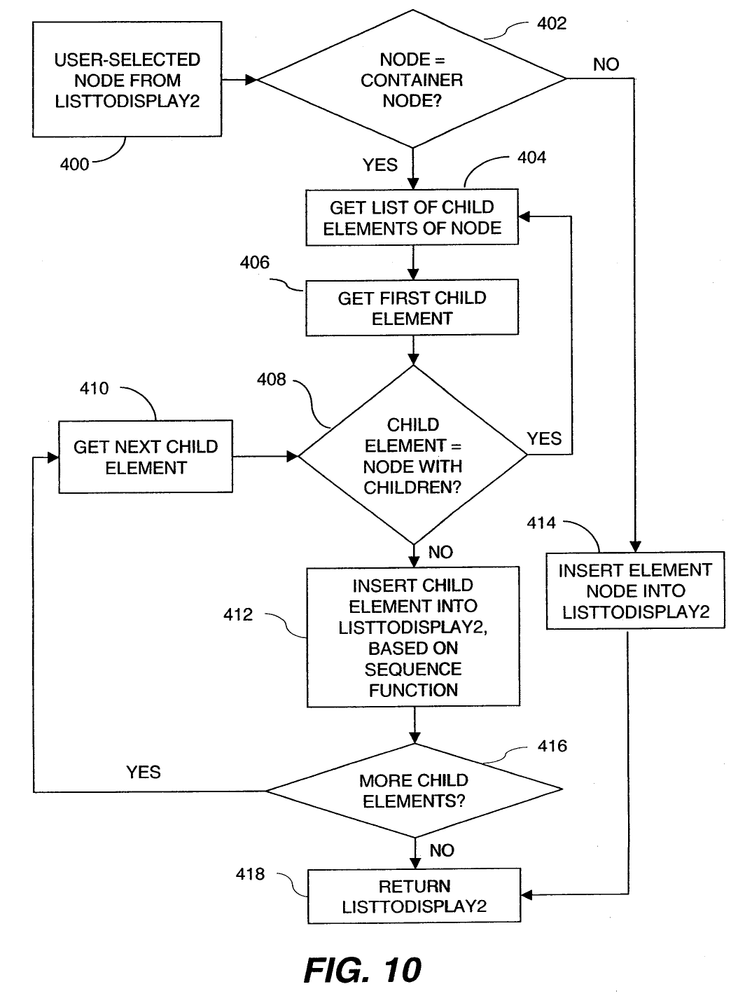

Using the ListToDisplay, the system can present the appropriate nodes from the NodesList and visual summary objects to users. FIG. 5 and FIG. 6 provide several abstract examples of displaying different ListToDisplay results to users. Once users have such a summary presented on a display, they need a mechanism for accessing the digital objects that are descendants of any node displayed. FIG. 10 provides a flowchart for generating a second ordered list of visual objects to display. Based on user selection in step 400, e.g. using a mouse pointer, of any given node from the ListToDisplay, then in step 402, if the selected node is not a container node, then it is a single leaf node. In this case, the node is inserted as the only item into ListToDisplay2 in step 414 and the ListToDisplay2 is returned in step 418. In step 402, if the user-selected node is a container node, then the flowchart will traverse the child elements of the node in a recursively depth first manner, collecting leaf nodes along the way. This process starts in step 404, where the list of child elements of the current node is retrieved. In step 406, the first child element from that list is then retrieved. In step 408, if the current child element is a node with children, then it is a container node and the flow chart recursively loops back to step 404, thereby getting the child elements of a child container node. In step 408, if the current child element does not contain children, then it is a leaf node. In step 412, a leaf node is inserted into ListToDisplay2, based on a sequence function. The sequence function can, for example, be used to order the ListToDisplay2 in forward chronological order based on the creation date of the digital object leaf nodes. In step 416, the method checks to see if more child elements are left to be processed. If yes, the next child element is retrieved in step 410 and it is processed as before, from step 408. If no child elements are left to be displayed, the ListToDisplay2 is returned.

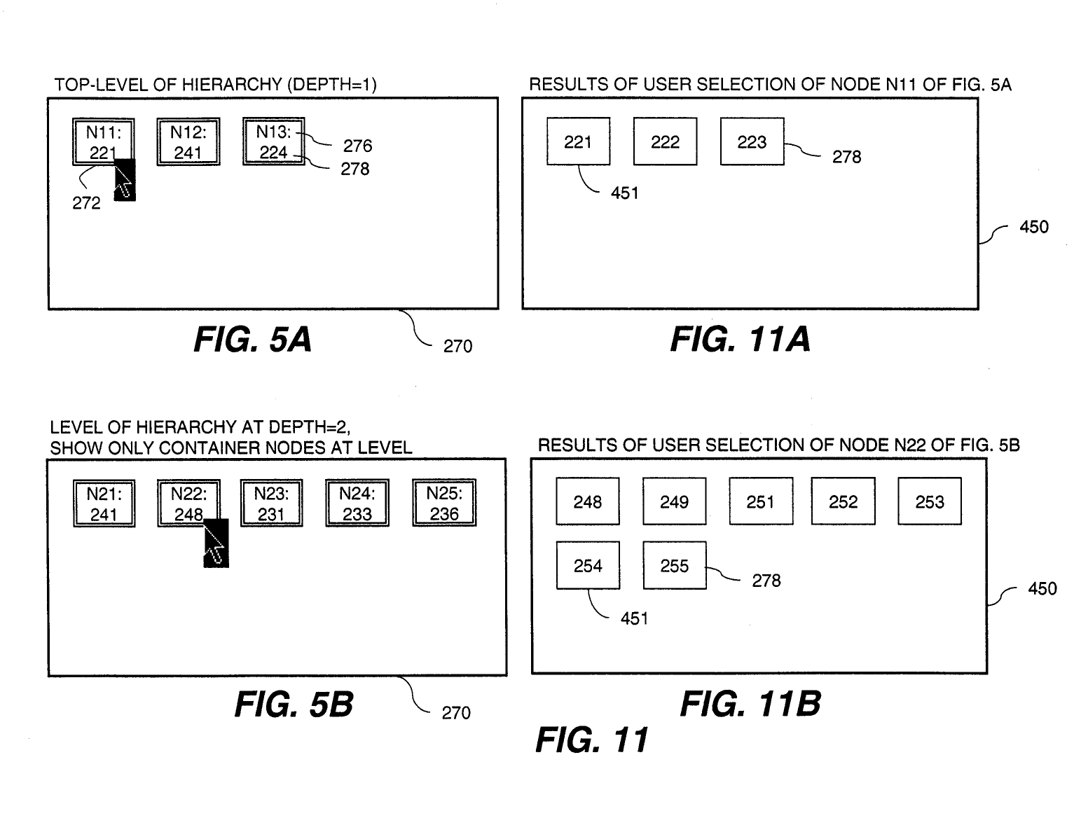

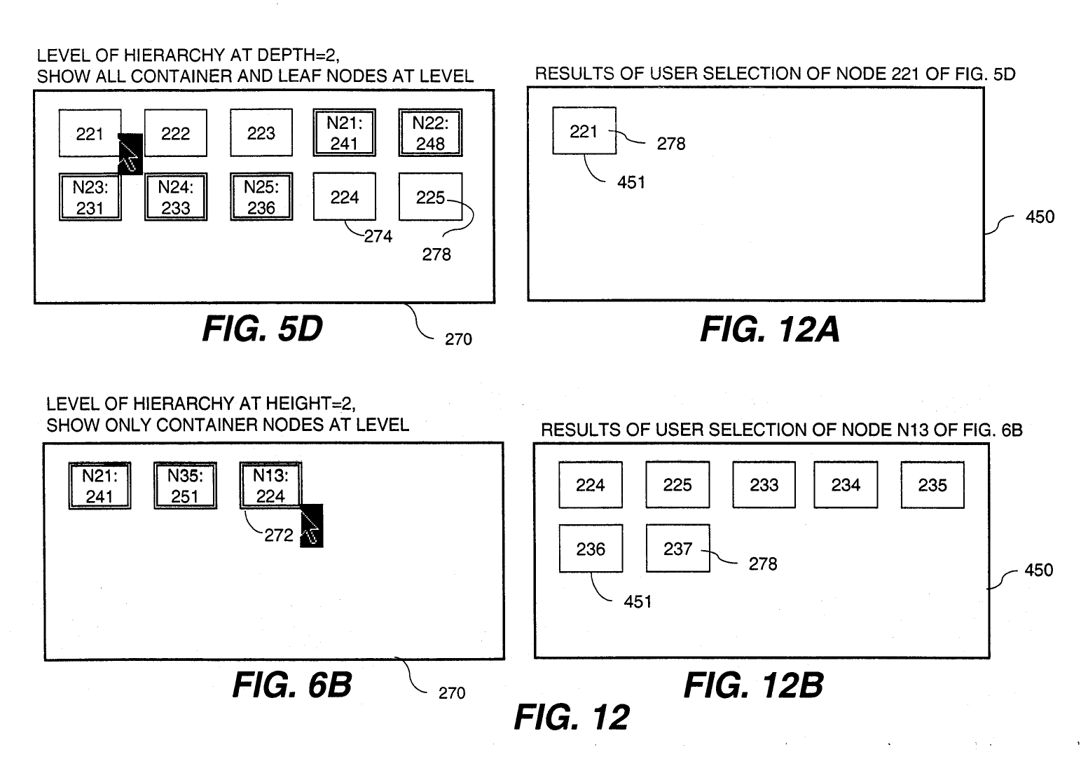

Example ListToDisplay2 results are provided in FIG. 11 and FIG. 12, based on a user selection of different nodes depicted in FIG. 5 and FIG. 6. FIG. 11A shows the ListToDisplay2 results of clicking on node n11 of FIG. 5A. FIG. 11B shows the ListToDisplay2 results of clicking on node n22 of FIG. 5B. FIG. 12A shows the ListToDisplay2 results of clicking on leaf node 221 of FIG. 5D. FIG. 12B shows the ListToDisplay2 results of clicking on node n13 of FIG. 6B. As illustrated in FIG. 11 and FIG. 12, a separate area 450 is provided on the display screen for displaying the ListToDisplay2 results. The ListToDisplay2 results 451 displayed in FIG. 11 and FIG. 12 could be visual depictions of the underlying digital objects of ListToDisplay2, such as thumbnail images for image objects. As in FIG. 5 and FIG. 6, the numbers 278 in the boxes indicate the object ID.

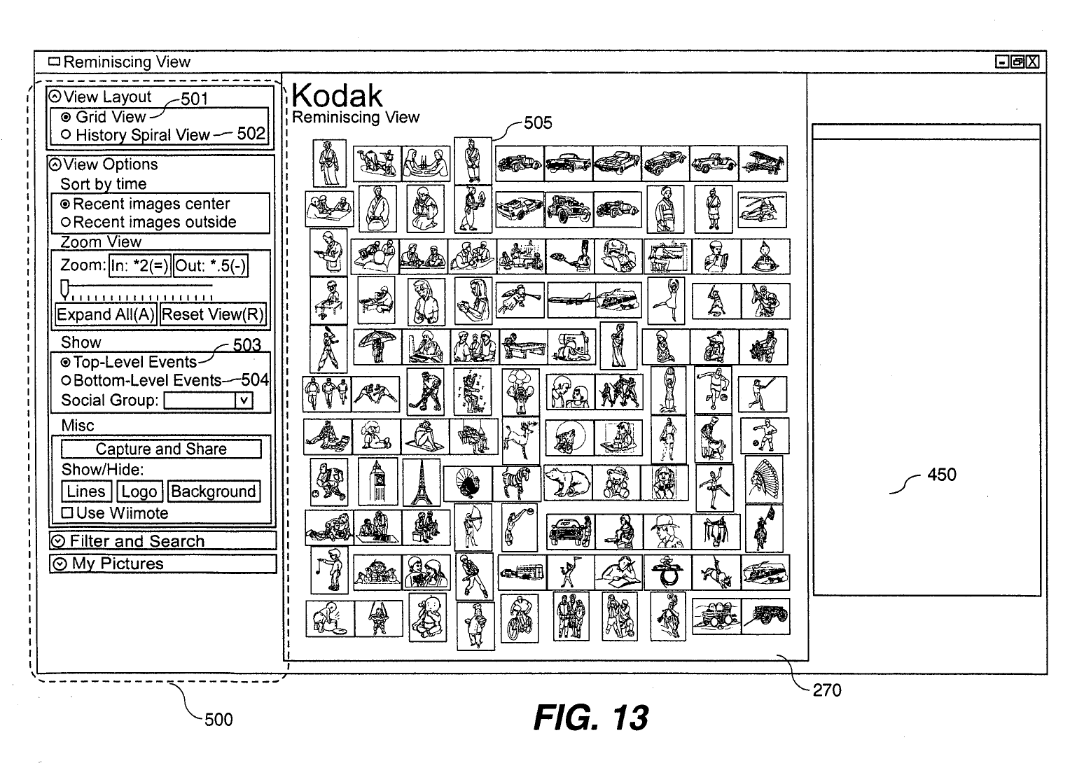

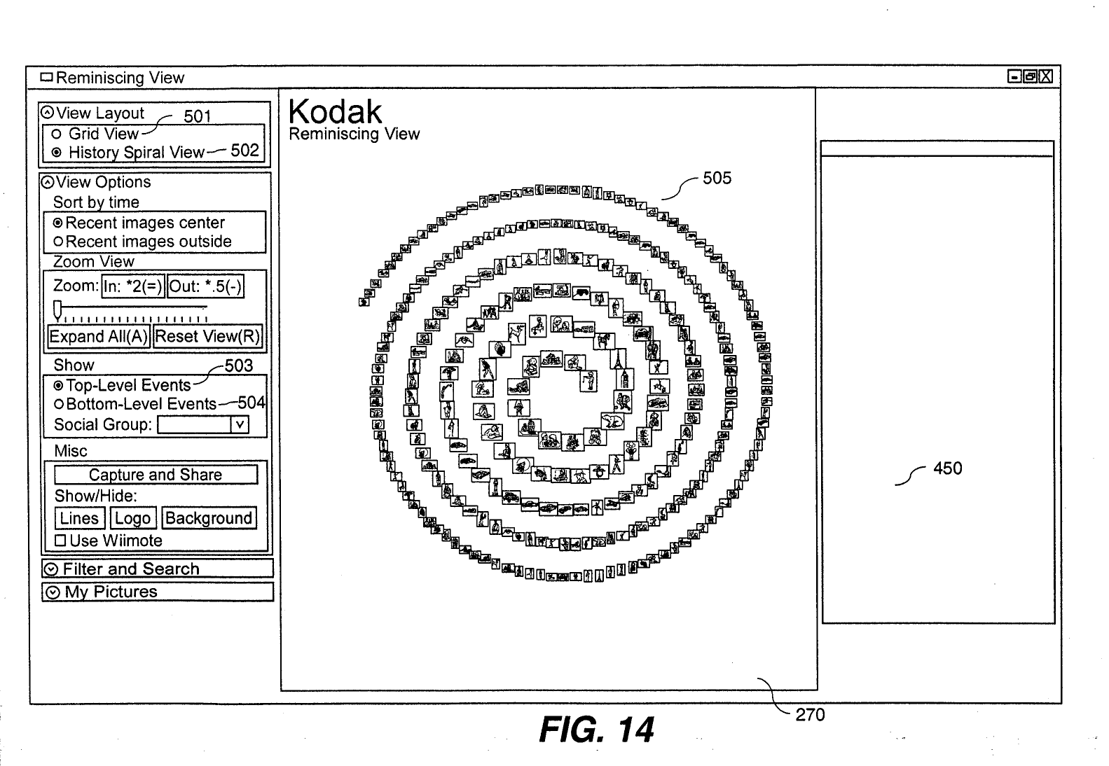

FIG. 13 to FIG. 17 show a series of several screen-captures of a working prototype implementing an embodiment of the present invention. (Note that the image thumbnails have been intentionally blurred, for privacy reasons. In the working prototype, the image thumbnails are not blurred.) Referring to FIG. 13, several display and filter options are provided on the left side 500 of the screen. There are two view layout options—a grid layout, accessible via the grid view radio button 501 and a spiral view layout, accessible via the history spiral view radio button 502. A sample grid layout is presented in FIG. 13 while sample spiral layouts are provided in FIG. 14 to FIG. 17. The prototype includes a display area 270 for presenting the ListToDisplay and a separate display area 450 for presenting the ListToDisplay2. In the prototype, users can access additional details about a node included in the center display (e.g., 505 of FIG. 13) by placing the mouse cursor over the node of interest and then retrieving the media associated with that node (i.e., ListToDisplay2) by clicking on the node.

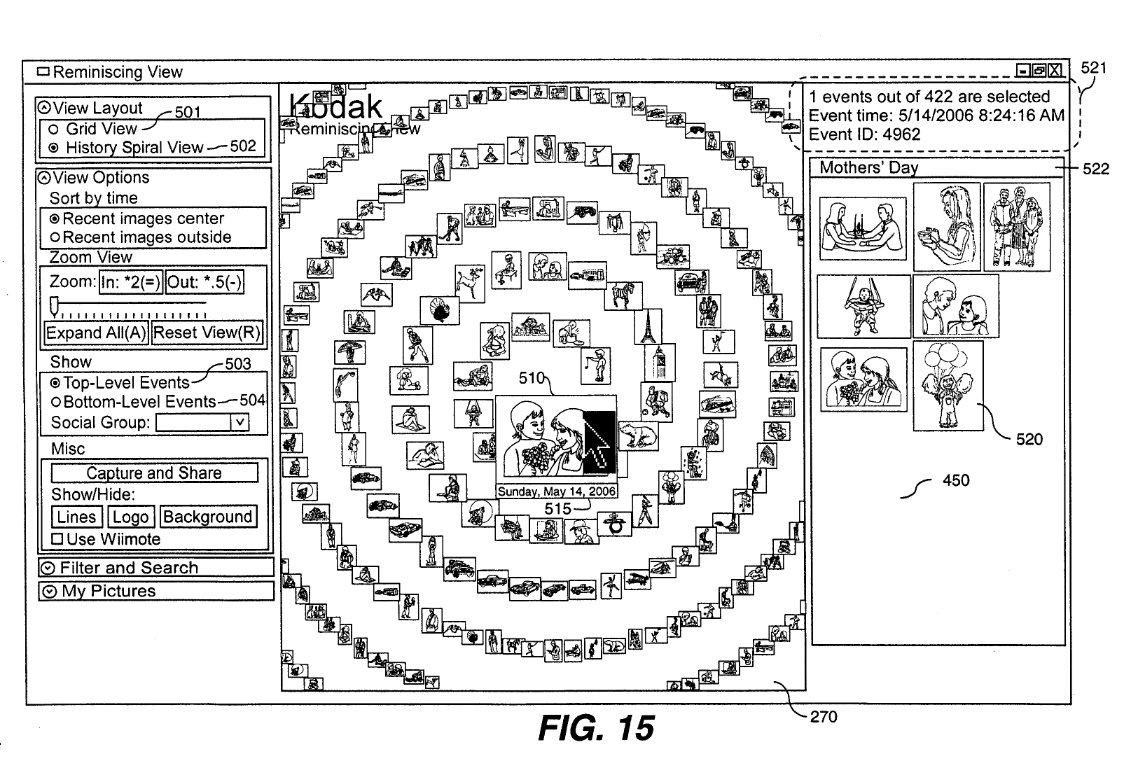

FIG. 15 shows a screen capture after the user has clicked on a thumbnail 505 from FIG. 14. For the node thumbnail image 510 over which the mouse cursor is hovering, date information 515 is provided for that event node and additional event details are presented in the details area 521. After the user clicks the node thumbnail image 510 with the mouse, thumbnail images (e.g., 520) of all images captured during that event are presented in the secondary display area 450. For American holidays, the system translates the date information into the holiday name and displays the information above the media in area 522.

### Alternative Schemes for Defining Hierarchy

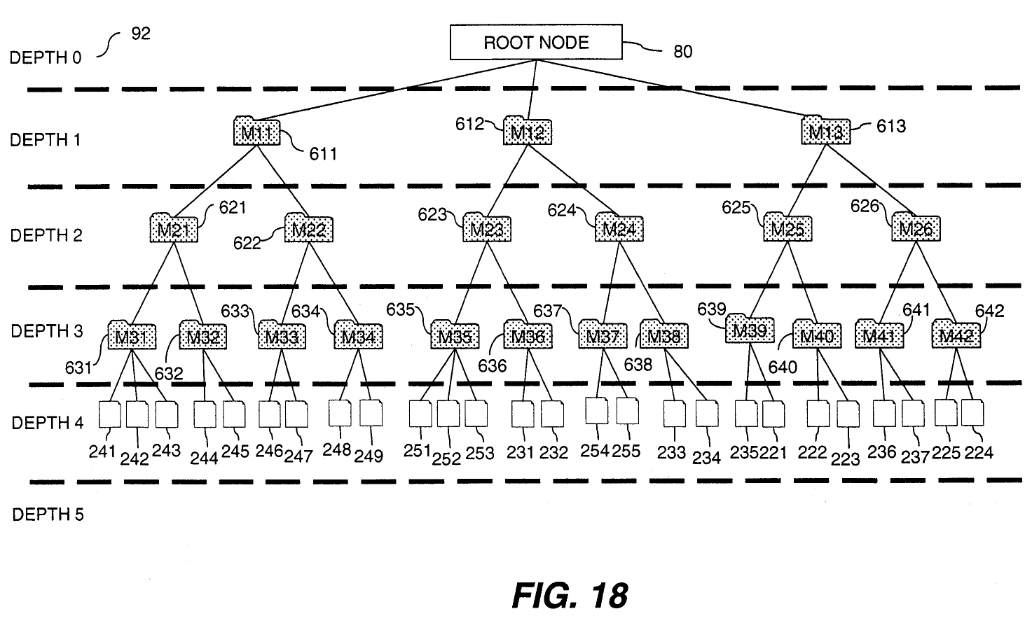

While most of the above examples focus on applying the current invention to data organized in a folder and file hierarchy, the current invention can be applied to any type of hierarchical data. In the case of a photo collection, other sample hierarchical organizations include event-based hierarchy, people-based hierarchy (e.g., based on family trees), content-based hierarchy, time-based and location-based hierarchies. Such hierarchies can be manually created or automatically derived by a suitably programmed computer system. In addition, the same collection of data may have more than one hierarchical organization, thereby allowing a user to browse a collection using the same interface applied to different aspects of the data. For example, assume that FIG. 3 represents a set of images hierarchically organized by one type of information such as date (e.g., by year, then month, then day of month, etc.). Assume that the same set of images have another type of hierarchical information associated with them, such as the country, state or region, and city where each picture was captured. In this case, the same set of images could be hierarchically organized by geographical information—by country first, then state or region, then city. FIG. 18 shows how the sample geographical hierarchy might look for the same digital objects depicted in FIG. 3. Note that although the hierarchical structure is very different between the figures, the same digital objects depicted as leaf nodes are present in both figures. If the user wanted to browse digital objects by date, the hierarchical data from FIG. 3 would be used in step 300 as input to the flowchart in FIG. 8 or FIG. 9. If the user wanted to browse digital objects by geographical information, the hierarchical data from FIG. 18 would be used in step 300 as input to the flowchart in FIG. 8 or FIG. 9.

The sample prototype depicted in FIG. 14 to FIG. 17 uses an event-based hierarchy. Given a collection of digital images, images can be automatically sorted into an event hierarchy based on capture information and content similarity of images. Event based image recognition is described in A. Loui, and E. Pavie, “A Method for Automatically Classifying Images Into Events,” U.S. Pat. No. 6,606,411, issued on Aug. 12, 2003, by A. Loui and E. Pavie, entitled: “A Method for Automatically Comparing Content of Images for Classification Into Events”. U.S. Pat. No. 6,351,556, issued on Feb. 26, 2002, by A. Loui, A. and A. Stent, entitled: “Method and System for Segmenting and Identifying Events in Images Using Spoken Annotations”. U.S. Pat. No. 7,120,586, issued on Oct. 10, 2006; by B. Kraus, and A. Loui, entitled: “Multi-tiered Image Clustering by Event”. U.S. patent application Ser. No. ______, currently pending, filed on Aug. 4, 2005, all of which are hereby incorporated by reference in their entirety. Using the prototype, users can choose to show only top-level events via radio button 503 or to show only bottom-level events via radio button 504. If the user chooses to show only top-level events, the flow chart of FIG. 7 is used to determine the NodeList for depth=1 of the event hierarchy. If the user chooses to show only bottom-level events, the flow chart of FIG. 8 is used to determine the NodeList for height=1 of the event hierarchy.

A people-based hierarchy could be applied to a collection of digital images by identifying each person in an image and mapping that image to a place in a family tree. A picture with more than one person in it could thus occur as a leaf node in more than one place in the tree. The method described in FIG. 10 for generating the ListToDisplay2 could be optionally modified in step 412 to only insert unique child elements into the ListToDisplay2. An advantage of using a people-based hierarchy applied to a collection is the ability to browse a collection based on the generation level of a family.

A content-based hierarchy could be applied to a collection of digital images based on the content of the images. For example, high-level categories in the hierarchy could include people, nature, animals, man-made objects, art, etc. Our approach could be especially useful for browsing a catalog of clip art where users are not familiar with all of the images in the collection. When users are less familiar with a digital object collection, it can be frustrating if user's keyword searches do not match keywords stored in the system. Browsing can then become tedious as users try to understand the type of taxonomy used to categorize objects. In our approach, users can easily access information at any level in the hierarchy, get visual summary of results and click on any node to retrieve all leaf nodes from that point in the hierarchy.

A time-based hierarchy for a collection of digital images could be automatically derived based on a Gregorian calendar and capture date and time of the digital images, where capture date and time can be extracted from EXIF header information stored in the digital image file as is well known in the art. While calendar-based interfaces to a digital collection are common in modern photo organization software, such interfaces typically focus on one of two mechanisms: A) users specify a date range and all images from that date range are displayed on the screen, or B) users get an overview of their images by year, and they can drill down from year, then to month, then to day to access images from a particular day. For option A, when a large number of images match the given date range, users must scroll through all images. In contrast, our approach only shows one visual summary object per node at a specified depth. Thus, for a date range selected from Jun. 1, 2000 to Sep. 30, 2001, users would see all images captured during that period using many modern photo organization software. Assuming that the user took 800 pictures during that time frame, then all 800 pictures would be displayed. In our approach, if users were looking at the level in the temporal hierarchy associated with month, they would only see at most 16 objects (i.e., one object per month in the period, less if some months contained no pictures). If users wanted more details, they could look at the next level of hierarchy which would include those associated with “week”.

In the case of option B of temporal browsing in typical modern photo organization software, users are typically browsing their collection by year and then month and then day. They cannot easily access a summary of photos taken during the summer, for example. They must go to each month and only view one month at a time. In contrast, our method would allow users to view multiple months at a time at a month summary level, week summary level, or day summary level.

A location-based hierarchy is becoming more commonly used for images and other digital objects that have GPS information associated with them. Such information is used, for example, to plot information on a map of the world, a country map, county map, city map, etc. The current invention could be used with a map display to support location-based browsing. In this context, zooming in on a displayed geographical region is equivalent to filtering the data to the currently displayed geographical region and setting the depth of the browsing used in the flow chart of FIG. 9 to correspond with the level of detail accessible at the currently displayed level. For example, our invention could show images at the “street” level, if the displayed map is zoomed in to a portion of a city, which would select images in geographic proximity to a particular street. While our invention can support such browsing that is available today, it can also support other types of location-based hierarchies that are not map-based. For example, a location-based hierarchy can be based on type of location such as residential (home, apartment), park (city park, camping area, national park), sports arena (high school, college, professional sports), school (elementary, middle school, high school, university), religious locations (church, synagogue), commercial (business, merchant), etc.

### Other Visual Layouts

FIG. 13 and FIG. 14 illustrate how different visual layouts can be used to display the first ordered list of nodes to the user. FIG. 13 uses a grid layout in the display area 270, while FIG. 14 uses a spiral layout in the display area 270. Other visual layouts can be used to depict different information about the data. For example, when looking at an event-based or time-based hierarchy, nodes could be visually clustered by year, holiday, or type of event (e.g., birthday, wedding, vacation, etc.).

### Depicting Node Details

Various node details may give users a better overview of, or help them to more efficiently browse, the hierarchically organized digital object collection. For example, when browsing by depth, knowing an individual container node's height provides information on how deep the descendant data of that node goes. Such height information of a node could also indicate the level of detail available for one or more of its descendant objects. When browsing by height, knowing a container's depth indicates how far the current node is from the root node.

The “size” of a container node can be used to refer to the number of descendant digital objects contained by said container node. The size of a container node can be an indicator of importance to a user. For example, in a digital image collection hierarchically organized by date, a really large sized node can indicate an important event such as a wedding, graduation, or a long vacation.

Node details such as the height, depth, or size of a node can be presented to the user through visual characteristics or embellishments to the visual representation of a node. In FIG. 14, the visual representations are image thumbnails 505 drawn along a spiral within screen area 270. The image thumbnails have different relative size, based on the year in which the corresponding event was captured—where larger thumbnails represent more recent events. This is an example of how size of a visual representation can be used to indicate date details about a node. We could instead use relative size of the thumbnails to indicate the size of an event (e.g., to indicate the relative number of images captured per event). Alternatively, different colored borders could be used around the thumbnails to indicate the size of an event, such as by using a yellow, blue, and gray border to indicate large, medium, and small-sized events.

Another characteristic that might be of interest to the user is node sibling information. Nodes are considered sibling nodes if they have the same parent. Differently colored lines linking the visual representations could be used to visually indicate sibling information. Alternatively, the system could highlight sibling nodes in response to a user hovering the mouse over a given node.

### Data Filtering

As data collections grow in size, data filtering becomes more important for improving the efficiency of browsing data. For hierarchically organized data, data filtering has the effect of pruning the tree hierarchy to only include items that match the current filter. Once a hierarchy has been pruned based on data filtering, the methods described in this invention can be directly applied to the pruned hierarchy.

Text-based queries are a common form of data filtering that are also supported in our prototype. For visual media such as images, other more complex data filters could be applied, such as visual search based on a region of interest from a photo, image similarity, face-based search based on a photo of a person, color-based search and so-on.

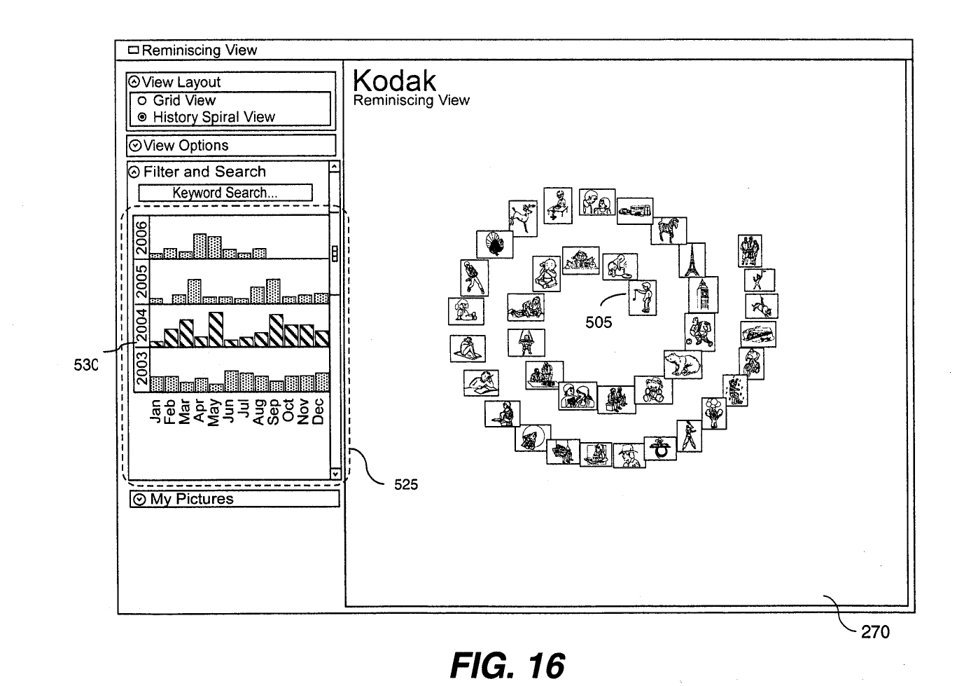

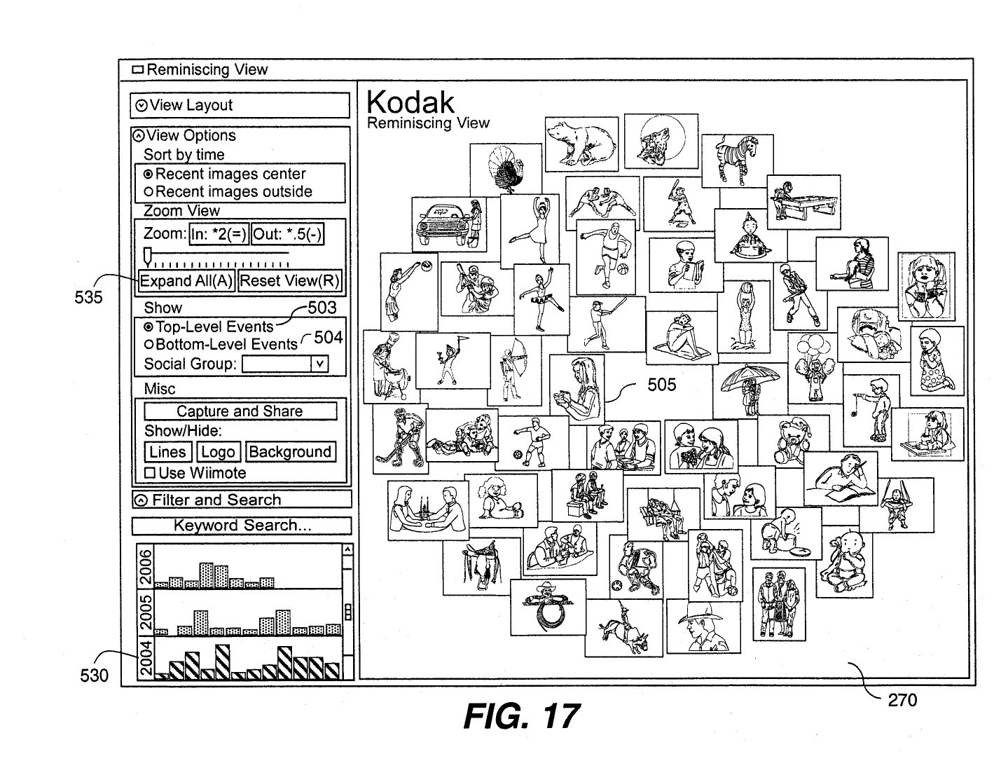

FIG. 16 and FIG. 17 show a bar plot 525 for filtering the given collection based on a month and year, that events were captured. Such a bar plot allows very fast temporal filtering of a collection. Users can click on a year of the bar plot to select all events that took place in that year; they can click on a month of the bar plot to see all events that took place in that month, through all of the years; or users can click on one or more month-year bars to select events that were captured during the corresponding selected time frames.

In FIG. 16, the user has clicked on year 2004 530 of the bar plot to select all events captured in that year. The display area 270 shows the results of this selection. This is in contrast to all top-level events of the whole collection that are depicted in the center display area 270 of FIG. 14. FIG. 17 shows the same information as FIG. 16 after the user has clicked on the “Expand All” 535 option to expand all thumbnails. Here, the user can clearly and easily view a summary of all events that took place in 2004.

Data filtering mechanisms can be aligned or totally unrelated to a given hierarchical structure. For a temporal hierarchy based on the Gregorian calendar, the bar plot 525 of FIG. 16 would be aligned with the temporal data hierarchy. However, a data filter could be provided that allows users to search the same temporal hierarchy by person. Person is separate from time, but could still be applied to work within the context of the current invention, as could any other type of data filter.

It will be understood that, although specific embodiments of the invention have been described herein for purposes of illustration and explained in detail with particular reference to certain preferred embodiments thereof, numerous modifications and all sorts of variations may be made and can be effected within the spirit of the invention and without departing from the scope of the invention. Accordingly, the scope of protection of this invention is limited only by the following claims and their equivalents.

### PARTS LIST

6 digital camera
10 personal computer
12 databus
14 CPU
16 read-only memory
18 network connection device
20 hard disk drive
22 random access memory
24 display interface device
26 audio interface device
28 desktop interface device
30 CD-R/W drive
32 DVD drive
34 USB interface device
40 DVD-based removable media such as DVD R− or DVD R+
42 CD-based removable media such as CD-ROM or CD-R/W
44 mouse
46 keyboard
48 microphone
50 speaker
52 video display
60 external network
80 root node of a hierarchical data structure
85 folder icon representing a container node in a hierarchical data structure
90 document icon
92 depth 0 of a hierarchical data structure
93 height 5 of a hierarchical data structure
95 largest depth D of a hierarchical data structure
111-113 container node
121-125 container node
131-135 container node
141-142 container node
221-225 leaf node
231-237 leaf node
241-249 leaf node
251-255 leaf node
270 screen region
272 double border
274 single border
276 container node id
278 leaf node id
300 block
302 block
305 block
307 block
310 block
312 block
315 block
320 block
322 block
324 block
326 block
328 block
330 block
335 block
342 block
344 block
345 block
348 block
350 block
352 block
354 block
356 block
358 block
360 block
365 block
375 block
380 block
382 block
385 block
390 block
395 block
398 block
400 block
402 block
404 block
406 block
408 block
410 block
412 block
414 block
416 block
418 block
450 screen region
451 visual depiction of digital object
500 screen region
501-504 radio button
505 thumbnail image
510 thumbnail image enlarged
515 date information
520 thumbnail image
521-522 screen region
525 multi-dimensional bar plot
530 year label 2004
535 button
611-613 container node
621-626 container node
631-642 CONTAINER NODE

What is claimed is:

1. A computer implemented method comprising the steps of:
locating a plurality of stored digital objects that are organized in a hierarchy; and
simultaneously displaying visual representations of at least some of the plurality of digital objects, including selecting said at least some of the plurality of digital objects to depict a preselected level of the hierarchy.

2. The method according to claim 1, wherein said preselected level of the hierarchy is a depth level.

3. The method according to claim 1, wherein said preselected level of the hierarchy is a height level.

4. The method according to claim 1, wherein the step of locating includes the step of locating a root node of the hierarchy.

5. The method according to claim 1, wherein the digital objects are selected from at least one of images, text documents, video clips, and presentation documents.

6. The method according to claim 1, wherein the visual representations are selected from at least one of a thumbnail of the digital object, a manually created graphic, and a computer generated image.

7. The method according to claim 1, wherein the visual representations incorporate an indication of a number of descendant digital objects.

8. The method according to claim 1, wherein the visual representations incorporate an indication of a hierarchical height within the hierarchy.

9. The method according to claim 1, wherein the visual representations incorporate an indication of a hierarchical depth within the hierarchy.

10. The method according to claim 1, wherein said step of selecting includes the step of selecting said at least some of the plurality of digital objects to symbolize only container nodes in the preselected level of the hierarchy.

11. The method according to claim 1, wherein said step of selecting includes the step of selecting said at least some of the plurality of digital objects to symbolize all container nodes and all leaf nodes, if any, in the preselected level of the hierarchy.

12. The method according to claim 1, wherein said step of selecting includes the step of selecting said at least some of the plurality of digital objects to symbolize only lowest possible container nodes in the preselected level and all smaller depth levels, if any, of the hierarchy.

13. The method according to claim 1, wherein said step of selecting includes the step of selecting said at least some of the plurality of digital objects to symbolize only highest possible container nodes in the preselected level and all smaller height levels, if any, of the hierarchy.

14. The method according to claim 1, wherein the step of simultaneously displaying visual representations includes selecting a layout based on a spiral pattern, a grid layout, a geographical map, or visually clustered by year, holiday, or type of event.

15. The method according to claim 1, wherein the step of simultaneously displaying further includes the steps of selecting one of the displayed visual representations symbolizing a container node and, in response thereto, displaying descendant leaf nodes of the container node.

16. The method according to claim 1, wherein an organization scheme of the hierarchy is selected from a time based hierarchy, an event based hierarchy, a people based hierarchy, a content based hierarchy, or a location based hierarchy.

17. A system comprising:
a processor accessible memory for organizing and storing a plurality of digital objects in a hierarchy;
a programmed processor for selecting at least one of the digital objects to be depicted by a preselected visual representation, each of said visual representations depicting a digital object in a preselected level of the hierarchy; and
a display screen for displaying the visual representations of the at least one of the digital objects selected by the processor.

18. The system according to claim 17, wherein an organization scheme of the hierarchy is selected from a time based hierarchy, an event based hierarchy, a people based hierarchy, a content based hierarchy, or a location based hierarchy.

19. The system according to claim 17, wherein each of said at least one of the digital objects symbolizes only a container node in the preselected level of the hierarchy.

20. The system according to claim 19, wherein each of said at least one of the digital objects symbolizes only one leaf node or one container node in the preselected level of the hierarchy.

21. A method of quickly reviewing digital objects stored in computerized folders that are organized in a hierarchy, comprising the steps of:
simultaneously displaying a first group of visual representations each symbolizing one folder of a plurality of folders that belong to one level of the hierarchy wherein all folders belonging to the one level are depicted; and
simultaneously displaying a second group of visual representations each depicting one digital object of a plurality of digital objects that belong to a lower level of the hierarchy in response to a user selecting to view said lower level of the hierarchy, wherein digital objects belonging to the lower level are depicted.

22. A program storage device readable by machine, tangibly embodying a program of instructions executable by the machine to perform the method steps of claim 1.
